(19) United States
(12) Patent Application Publication
(10) Pub. No.: US 2011/0167718 A1
(43) Pub. Date: Jul. 14, 2011

(54) PRESSURIZED CHRISTMAS TREE WATERING SYSTEM

(76) Inventors: Carl L.C. Kah, JR., North Palm Beach, FL (US); Deborah Avis, Palm Beach, FL (US)

(21) Appl. No.: 12/987,501

(22) Filed: Jan. 10, 2011

Related U.S. Application Data
(60) Provisional application No. 61/293,425, filed on Jan. 8, 2010.

(51) Int. Cl. A47G 33/12; A01G 25/00

(52) U.S. Cl. 47/40.5; 47/57.5

(57) ABSTRACT

A watering system for a tree such as a Christmas tree, or other plant, in accordance with an embodiment of the present application includes a low pressure water source, a fluid connection line and an interface watering device connected to the tree. The interface watering device may be a cup, a stopper, or threaded fitting, for example that provides water from the water source via the line to the water source. A method for supplying fluid matter into plants or trees in accordance with an embodiment of the present application includes drilling a hole into the plant stem or trunk and installing a pressure tight connection in the hole so that fluid may be forced into the plant or tree.

### CROSS-REFERENCE TO RELATED APPLICATIONS

The present application claims benefit of and priority to U.S. Provisional Patent Application Ser. No. 61/293,425 filed Jan. 8, 2010 entitled PRESSURIZED CHRISTMAS TREE WATERING SYSTEM, the entire content of which is hereby incorporated by reference herein.

### BACKGROUND

1. Field of the Disclosure

The present disclosure relates to a pressurized watering system for use with Christmas trees or other plant life. More specifically, the present application relates to a watering system that includes a water container or reservoir that is easily accessible and refillable and that provides a substantially constant supply of water to a Christmas tree or other plant at low pressure.

2. Related Art

Christmas trees, after being cut, loose moisture fairly rapidly. To extend their attractiveness, the trees need to be provided with at least water. Typically, this is done by placing the cut-off bottom of the trunk in water, in a manner similar to that used with cut flowers.

This is generally accomplished by including a water retention bucket in a tree stand into which the cut-off end of the tree is mounted. Some trees may suck up as much as ½ gallon to 1 gallon of water per day through the freshly re-cut bottom of the tree trunk, particularly where the cut tree has not had water since being cut, shipped and stored for sale. Thus, users need to refill the water retention bucket often, which can be time consuming and inconvenient.

Accordingly, it would be desirable to provide a watering system that avoids these problems and preferably is applicable to trees as soon as they are cut, if desired.

### SUMMARY

It is an object of the present disclosure to provide a watering system that provides a flow of water, and perhaps nutrients, to a tree or other plant material over a long period of time under a low pressure or to allow the tree to suck the water from a bladder or other container on its own.

A watering system in accordance with an embodiment of the present application preferably includes a low pressure water source that provides a substantially constant supply of water to a Christmas tree or other plant.

A watering system for a tree in accordance with an embodiment of the present application includes a water source, a connecting tube in fluid communication with the water source and an interface device configured and operable for connection to a trunk of the tree and including an inlet in fluid communication with the connecting tube to supply water to the tree.

A method for supplementing nutrients and fluid to a plant in accordance with an embodiment of the present disclosure includes drilling a hole of a desired diameter in a trunk of the plant, installing an interface device configured and operable to provide at least water to the plant in the hole and connecting the interface device to a pressurized supply of water and nutrients.

Other features and advantages of the present invention will become apparent from the following description of the invention which refers to the accompanying drawings.

### BRIEF DESCRIPTION OF THE DRAWINGS

FIG. 1 shows a tree with a watering system including a supply cup attached to the bottom of its trunk and a water bag for gravity feeding hung up in the tree limbs in accordance with one embodiment of the present application.

FIG. 2 shows a tree with a drill hole and a watering system including a plug fitting, or stopper, for pressure feeding water and nutrients to the tree from a hand pumped pressurized water container in accordance with another embodiment of the present application.

FIG. 3 shows a tree standing in a conventional Christmas tree stand with a water bucket at its base and including a watering system with pressure supplied by a pumped pressure water reservoir to a fitting which has been screwed into a hole drilled into the tree trunk as well as pressurized water being supplied to a flow control auto fill valve for the tree stand water bucket.

FIG. 4 shows a cross section view of a tree trunk with a self tapping threaded fitting screwed into a drilled hole in the tree trunk for connection to a water supply tube.

FIG. 4A illustrates a more detailed view of an embodiment of the threaded fitting with a handle for turning by hand.

FIG. 4B illustrates a more detailed view of an embodiment of a threaded fitting with an element for turning with a tool.

### DETAILED DESCRIPTION OF THE EMBODIMENTS

The watering system of the present application attempts to replace or supplement osmotic pressure that is used to hydrate living trees. The watering system of the present disclosure is similar to the intravenous feeding of fluid and nutrients into the blood stream of humans. In the watering system of the present application, however, water, and possibly other nutrients are provided to sustain the life of a tree after being separated from its root supply.

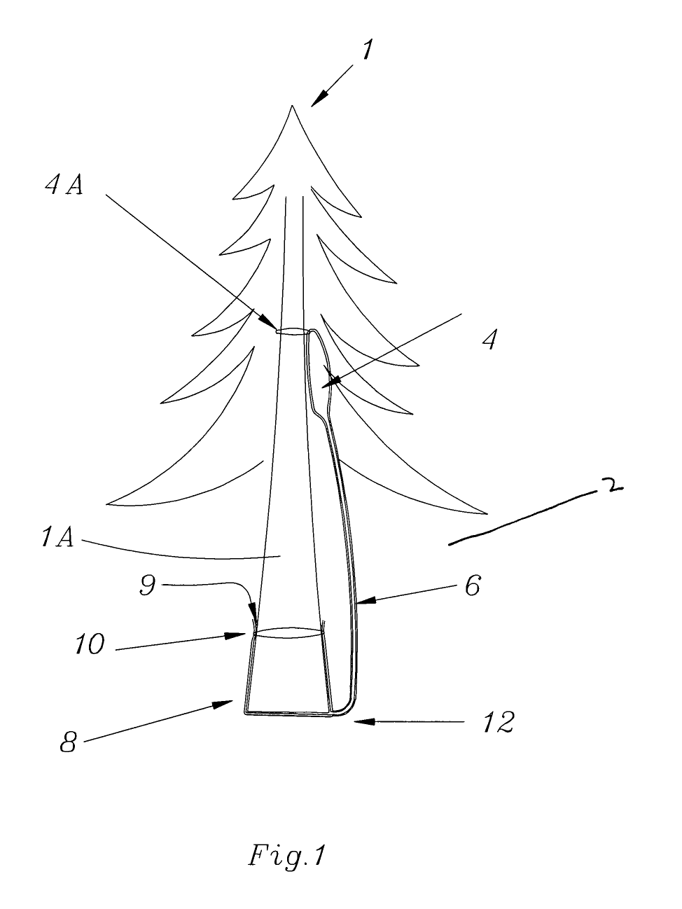

FIG. 1 illustrates a tree 1 with a watering system 2 in accordance with an embodiment of the present application. The system 2 preferably includes a pressurized, preferably gravity pressurized, source of water 4. That is, pressure may be provided to move water from the source 4 to the tree 1 by gravity if the tree 1 is standing. Otherwise, water may be drawn into the tree 1 by osmotic forces from the supply 4. In a preferred embodiment, a small fluid conducting line, or tube 6 is connected to the water source 4 and to a rubber cup 8 preferably positioned around the bottom end of the tree trunk 1A to provide water from the source to the tree. The cup 8 may be manufactured in several sizes for different size tree trunk bottoms. Alternatively, the cup may be stretched to accommodate different sizes. While the cup 8 is described as a rubber cup, any substantially elastic material may be used. In addition, while the cup 8 is illustrated as a cup, any suitable interface device may be used to provide water to the tree 1 from the supply 4.

A connecting supply tube hole, or inlet 12 is provided in the cup 8 for connection to the line 6 to allow the water from the water supply 4 to pressurize the bottom of the tree trunk 1A. While the rubber cup 8 is a preferred interface with the tree 1 in the system of FIG. 1, any similar structure that extends over the bottom of the freshly cut trunk of the tree may be used. The cup 8 is preferably sealed with a clamp 10, pull tie or other restraint, around a rubber lip thereof which extends upward around the bottom of the cut trunk 1A. A further low pressure seal may be provided with a paste caulking 9 between the bark and the cup lip, if desired.

In the system 2 of FIG. 1, the water source 4 may be a plastic water bag that is hung from hanger 4A from the tree 1 itself. Thus, gravity provides for low pressure flow of water from the water bag 4, through the line 6 and to the cup 8, at the cut bottom of the trunk 1A. In this manner, a substantially constant flow of water is provided to the tree 1 over a long period of time. Since the water is contained in the water bag 4, it may be refilled or replaced easily. Filling or replacing the bag may be performed during shipping and handling of the tree 1 prior to the tree being put into a tree stand as well. Even if the position of the tree 1 during shipping, for example, does not allow for gravity feeding, the tree may absorb water via osmotic action. As a result, the tree 1 will remain hydrated throughout its journey from forest to home.

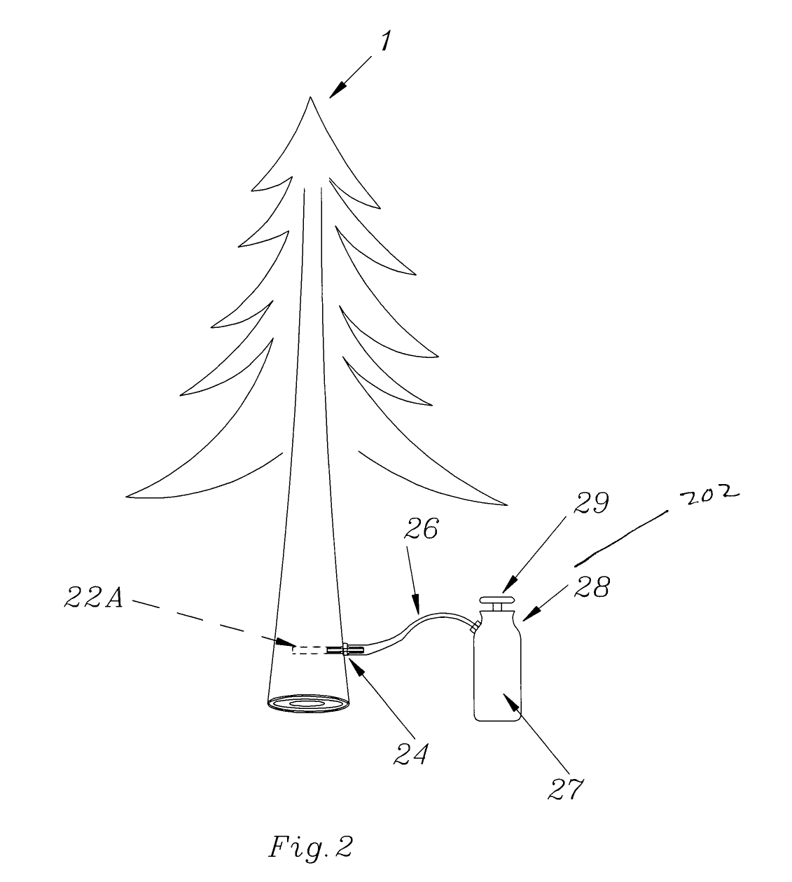

FIG. 2 illustrates another embodiment of a watering system 202 where one or more holes 22A are drilled in the trunk 1A of the tree 1 at one or more location. As single hole 22A is shown in FIG. 2, however additional holes may be used, if desired. The holes 22A preferably have a diameter of approximately ⅜ of an inch, however, any suitable diameter may be used. A rubber stopper 24 may be placed in the hole 22A to seal it from the outside. Pressurized water is provided, through an opening in the center of the rubber stopper from a low pressure water supply 28. Nutrients may also be provided with the water in the systems of both FIG. 1 and FIG. 2, if desired. The water and nutrients replace the water and nutrients that normally would have been supplied by the tree's root systems when it was living in the wild. The rubber stoppers 24 may be retained in place by a pull tie around the rubber stopper or friction fit in the hole 22A. Where a pull tie is used, an opening for the line or tube 26 to provide water to the opening in the stopper 24 from the supply 28 is provided. The opening in the stopper 24 is preferably in a substantial center thereof and is in fluid communication with the line 26 such that water passes through the stopper and into the tree 1.

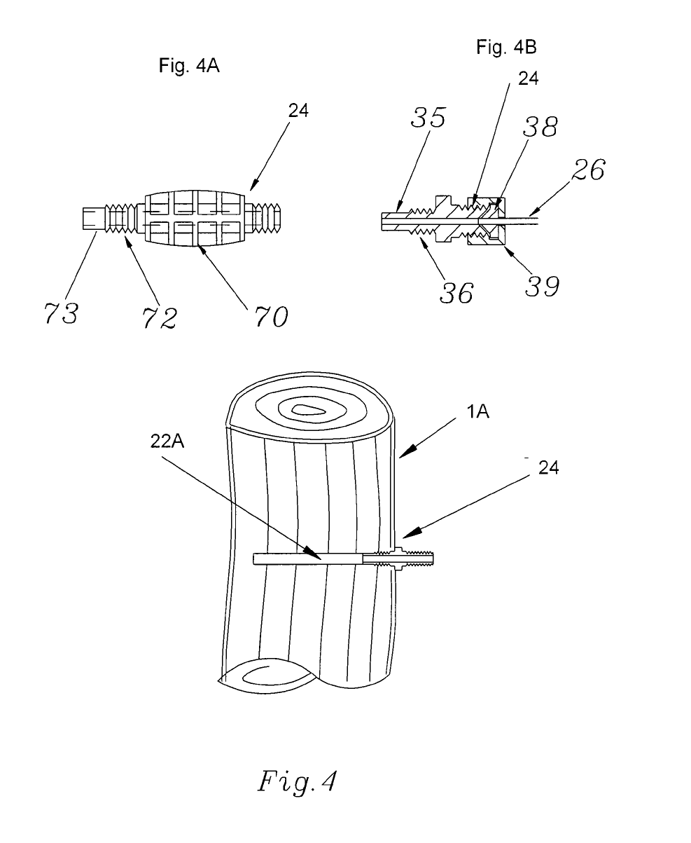

Alternatively, the stopper 24 may be embodied as a threaded fitting. Both the threaded fitting and stopper 24 are suitable embodiments of the interface device discussed above. The threaded fitting 24 may be screwed into the hole 22A in the tree trunk 1A using self tapping fitting threads 72, 36 (See FIGS. 4A and 4B, for example). The nose 73, 35 of the fitting 24 may be sized to tightly fit in the inside diameter of the hole 22A.

As shown in FIG. 2, the water supply 28 may be a pumped air pressurized water container 27, which is pressurized by air with a hand pump 29. This pressure will ensure a sufficient flow of water to the tree 1. The hand pump 27 allows pressure to be easily established and maintained by the user. The higher pressure ensures pushing fluid into the tree trunk 1A. The wood in the trunk 1A is porous and distributes the fluid around the outer circumference of the tree trunk into the bark where the tree's primary circulation is located. A fluid conducting line, or tube 26 similar to the line 6 illustrated in FIG. 1 may be used to provide the water from the container 27 to the stoppers or threaded fitting 24. Alternatively, the water bag 4 of FIG. 1 may be used in place of the container 27. In this case, the watering system 202 acts much like intravenous feeding system for humans by hanging a bag of fluids, which provides injection pressure using gravity. Similarly, the water source 28 of FIG. 2 may be used in place of the plastic bag 4 used in the system 2 of FIG. 1, if desired.

Feeding trees, or other plant life, by drilling a hole into their trunk, or stem, and attaching a water or nutrient source to “intravenously” feed the tree or plant may also be done while the plant or tree is still attached to its root system. Thus, the watering system of the present application may be used with a plant or tree even before it is cut. If a nutrient fluid is used, only small amounts of nutrients are required for each plant, or tree since there is no need to spread the nutrients out over large areas around the trees on the ground, as would be done with conventional fertilizer, for example. This avoids nutrient losses due to excessive rain fall. Further, use of the watering system with a nutrient liquid may provide a way for large existing trees with damaged root systems to be hydrated and nourished. Where the root system on one side of a tree has been damaged which results in part of the tree dying or being blighted, a hole could be drilled into this side of the tree and nutrient fluid provided to the tree until the damaged tree adjusts to the root damage.

The water supply bags 4, cups 8 or plugs 24 may be used in trees, as described above, or in other plants, for example, ornamental plants, at the time they are cut. Indeed, the watering system described herein would be appropriate for use for other types of plants and flowers that are cut and then used for extended time as decorations.

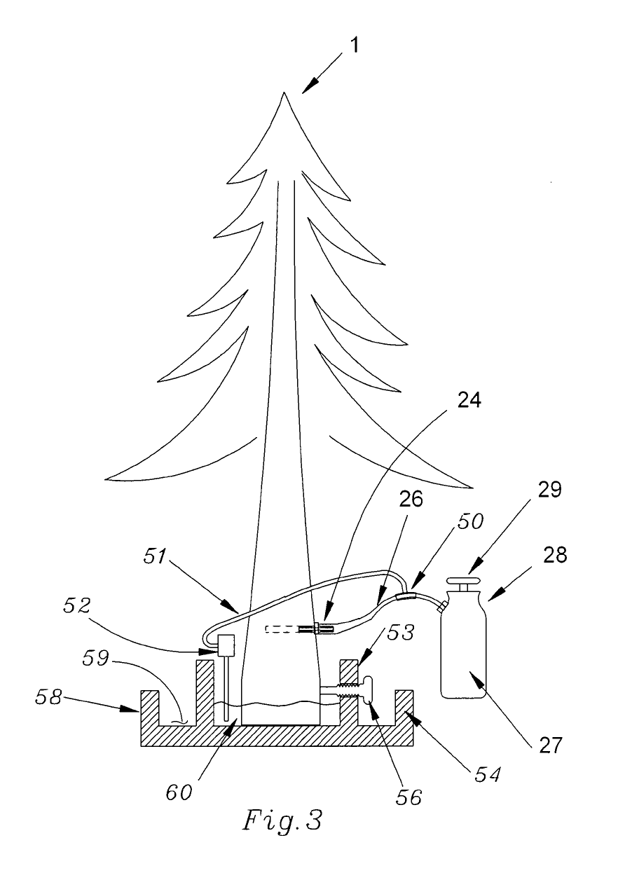

In FIG. 3, a tree 1 is shown in a tree stand 58. A separate line or tube 51 is provided in addition to the tube 26, which is connected to the threaded fitting 24. The line 51 is illustrated as connected to the line 26 at junction 50 in FIG. 3, however, the line 51 may be connected directly to source 28, if desired. The line 51 is in fluid communication with a float valve 52 that will automatically maintain a desired water level in the water container 60 at the bottom of the tree stand 58. Thus, in the embodiment of FIG. 3, the pressurized water supply 28 may be used to maintain the desired water level in the tree stand 58 automatically. The tree stand 58 may also have a separate outer circumferential compartment area 59 to contain any water that might overflow from the water container 60 at the bottom of the tree 1. Otherwise the system illustrated in FIG. 3 operates in substantially the same manner as that of FIG. 2 and common reference numerals are used to refer to common elements.

FIG. 4 illustrates a more detailed view of a threaded fitting 24 inserted into the trunk 1A of a tree 1. FIG. 4A illustrates a more detailed view of an embodiment of the fitting 24 that includes a handle area 70 to allow for the fitting to be screwed into the opening 22A by hand. FIG. 4B illustrates another embodiment of the fitting 24 including a tool insert 39 configured to allow for the fitting to be screwed into the tree 1 with a socket or other tool.

Although the present invention has been described in relation to particular embodiments thereof, many other variations and modifications and other uses will become apparent to those skilled in the art.

What is claimed is:

1. A watering system for a tree comprising:
a water source;
a connecting tube in fluid communication with the water source; and
an interface device configured and operable for connection to a trunk of the tree and including an inlet in fluid communication with the connecting tube to supply water to the tree.

2. The watering system of claim 1, wherein the water source further comprises a hanger configured and operable to hang the water source at a desired height such that gravity provides a low pressure flow of water out of the water source to the tree.

3. The watering system of claim 1, wherein the water source includes an inlet configured and operable to receive water such that the water source is refillable.

4. The watering system of claim 1, wherein the water source is removably connected to the connecting tube such that the water source is removable from the watering system when it is empty.

5. The watering system of claim 2, wherein the water source is a flexible bag including an amount of water.

6. The watering system of claim 1, wherein the interface device is a rubber cup configured and operable for attachment to a bottom end of a trunk of the tree.

7. The watering system of claim 6, wherein the rubber cup includes an inlet opening configured and operable for connection to the connecting tube such that water from the connecting tube is provided to the tree.

8. The watering system of claim 6, further comprising a fastener configured and operable to secure the rubber cup to the trunk of the tree.

9. The watering system of claim 6, further comprising a low pressure caulk seal provided between the tree trunk and the rubber cup at a top of the rubber cup.

10. The watering device of claim 1, wherein the water source is a low pressure container including a hand pump configured and operable to adjust air pressure in the container such that a steady flow of water out of the container and into the connecting tube is provided.

11. The watering device of claim 1, wherein the interface device is a stopper including a central opening in fluid communication with the connecting tube, wherein the stopper is configured for placement in a hole formed in a trunk of the tree.

12. The watering device of claim 1, wherein the interface device is a threaded fitting including a central opening in fluid communication with the connecting tube, wherein the threaded fitting is configured and operable to be screwed into a hole formed in a trunk of the tree.

13. The watering device of claim 12, wherein the threaded fitting includes self tapping threads on a first end thereof.

14. The watering device of claim 12, wherein the threaded fitting includes a handle portion configured and operable to aid a user in screwing the threaded fitting into the hole by hand.

15. The watering device of claim 12, wherein the threaded fitting includes a tool element configured and operable to aid a user in screwing the threaded fitting into the hole using a tool.

16. The watering system of claim 1, further comprising:
a tree stand configured and operable to receive a lower end of a trunk of the tree;
the tree stand including:
a water bucket configured and operable to hold an amount of water such that the lower end of the trunk of the tree is in the water; and
a float valve provided in the water bucket and configured and operable to open and close to maintain a desired amount of water in the water bucket; and
a second connecting tube connected between the water source and the float valve to provide water to the water bucket to maintain the desired amount of water in the water bucket.

17. A method for supplementing nutrients and fluid to a plant comprises:
drilling a hole of a desired diameter in a trunk of the plant;
installing an interface device configured and operable to provide at least water to the plant in the hole; and
connecting the interface device to a pressurized supply of water and nutrients.
